(19) United States
(12) Patent Application Publication
(10) Pub. No.: US 2006/0168565 A1
(43) Pub. Date: Jul. 27, 2006

(54) Method and system for change classification

(75) Inventors: Erich Gamma, Gutenswil (CH); Barbara G. Ryder, Metuchen, NJ (US); Maximilian Storzer, Passau (DE); Frank Tip, Ridgewood, NJ (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 11/041,447

(22) Filed: Jan. 24, 2005

(51) Int. Cl. G06F 9/44

(52) U.S. Cl. 717/122

(57) ABSTRACT

A method comprises steps of: obtaining an original version and a modified version of a program wherein each version has a set of associated tests; determining a set of affected tests whose behavior may have changed as a result of one or more changes made to the original version to produce the modified version; determining a set of changes responsible for changing the behavior of at least one affected test; and classifying at least one member of the set of changes according to the way the member impacts at least one of the tests.

### STATEMENT REGARDING FEDERALLY SPONSORED-RESEARCH OR DEVELOPMENT

N/A

### FIELD OF THE INVENTION

The invention disclosed broadly relates to the field of information processing systems, and more particularly relates to the field of error detection in software development.

### BACKGROUND OF THE INVENTION

The extensive use of sub-typing and dynamic dispatch in object-oriented programming languages may make it difficult for programmers to understand value flow through a program. For example, adding the creation of an object may affect the behavior of virtual method calls that are not lexically near the allocation site. Also, adding a new method definition that overrides an existing method can have a similar non-local effect. This non-locality of change impact is qualitatively different and more important for object-oriented programs than for imperative ones (e.g., in C programs a precise call graph can be derived from syntactic information alone, except for the typically few calls through function pointers).

Change impact analysis consists of a collection of techniques for determining the effects of source code modifications. See Bohner, S. A., and Arnold, R. S., An introduction to software change impact analysis. In Software Change Impact Analysis, S. A. Bohner and R. S. Arnold, Eds. IEEE Computer Society Press, 1996, pp. 1-26 (Bohner and Arnold); Law, J., and Rothermel, G., Whole program path-based dynamic impact analysis. Proc. of the International Conf. on Software Engineering, (2003), pp. 308-318 (Law and Rothermel); and Orso, A., Apiwattanapong, T., and Harrold, M.J., Leveraging field data for impact analysis and regression testing. In Proc. of European Software Engineering Conf. and ACM SIGSOFT Symp. on the Foundations of Software Engineering (ESEC/FSE'03) (Helsinki, Finland, September 2003) (Orso, 2003); Ryder, B. G., and Tip, F., Change impact for object oriented programs. In Proc. of the ACM SIGPLAN/SIGSOFT Workshop on Program Analysis and Software Testing (PASTE01) (June 2001)(Ryder and, Tip 2001); and Orso, A., Apiwattanapong, T., Law, J., Rothermel, G., and Harrold, M. J., An empirical comparison of dynamic impact analysis algorithms. Proc. of the International Conf. on Software Engineering (ICSE'04) (Edinburgh, Scotland, 2004), pp. 491-500 (Orso 2004).

Change impact analysis can improve programmer productivity by: (i) allowing programmers to experiment with different edits, observe the code fragments that they affect, and use this information to determine which edit to select and/or how to augment test suites; (ii) reducing the amount of time and effort needed for running regression tests (the term “regression test” refers to unit tests and other regression tests), by determining that some tests are guaranteed not to be affected by a given set of changes; and (iii) reducing the amount of time and effort spent in debugging, by determining a safe approximation of the changes responsible for a given test's failure. See Ryder, Tip 2001; and Ren, X., Shah, F., Tip, F., Ryder, B. G., Chesley, O., and Dolby, J., Chianti: A prototype change impact analysis tool for Java. Tech. Rep. DCS-TR-533, Rutgers University Department of Computer Science, September 2003 (Ren et al. 2003).

Testing of software is a critical part of the software development process. There is a need for development of tools that help programmers understand the impact of changes in different versions of programs that assist with debugging when changes lead to errors, report change impact in terms of unit tests, and integrate well with current best practices and tools.

Known tools include: (1) Chianti: an eclipse plug-in that reports change impact and finds tests affected by changes that affect a given test; and (2) JUnit/CIA: an extension of JUnit that incorporates some of Chianti's functionality. Chianti is a tool for change impact analysis of Java programs. See OOPSLA 04, Oct. 24-28, 2004. JUnit is a simple framework to write repeatable tests. It is an instance of the xUnit architecture for unit testing frameworks. The current practice is to only check in code when all tests succeed. This is not consistent with the goal of exposing changes quickly to other members of the programming team. Therefore, there is still a need for a system and method to help programmers find the reason for test failures in software systems that have associated unit tests. Moreover, there is a need in the art for a tool that allows programmers to identify those changes that do not adversely affect the outcome of any test, and that can be committed safely to a version control repository. In particular there is a need for a tool that: assists with debugging when changes lead to errors; reports change impact in terms of unit tests; and integrates well with current best practices and tools.

### SUMMARY OF THE INVENTION

To solve the foregoing problems we analyze dependences in program code changes to determine changes that can be checked in safely. Briefly according to an embodiment of the invention, a method comprises steps of: obtaining an original version and a modified version of a program, wherein each version has a set of associated unit tests; determining a set of affected tests whose behavior may have changed; determining, for each affected test, the set of changes that may have affected the behavior of that test; and providing a classification for each member of the set of changes according to the ways in which the changes impact the tests.

### BRIEF DESCRIPTION OF THE DRAWINGS

FIG. 1 is a flow chart illustrating a simplified method according to an embodiment of the invention.

FIG. 2A shows an example of an original version of the program to be modified.

FIG. 2B shows an edited version of the program of FIG. 2A, where the changes are shown using underlining.

FIG. 3 shows tests associated with the example program.

FIG. 4 shows the atomic changes that define the two versions of the example program.

FIG. 5 shows the call graphs for the three tests test1, test2, and test3 of FIG. 3, before the changes have been applied.

FIG. 6 shows the call graphs for the three tests test1, test2, and test3 of FIG. 3, after the changes have been applied.

FIG. 7 shows the affecting changes for each of the tests.

FIG. 8 shows the result of running three tests against an old version of a program and against a new version of the program.

FIG. 9 shows the classification of the atomic changes of FIG. 4.

FIG. 10 shows equations for computing affected tests and affecting changes.

FIG. 11 shows a set categories of atomic changes.

FIG. 12 shows addition of an overloaded method.

FIG. 13 shows a hierarchy change that affects a method whose code has not changed.

### DETAILED DESCRIPTION

### 1.0 Introduction

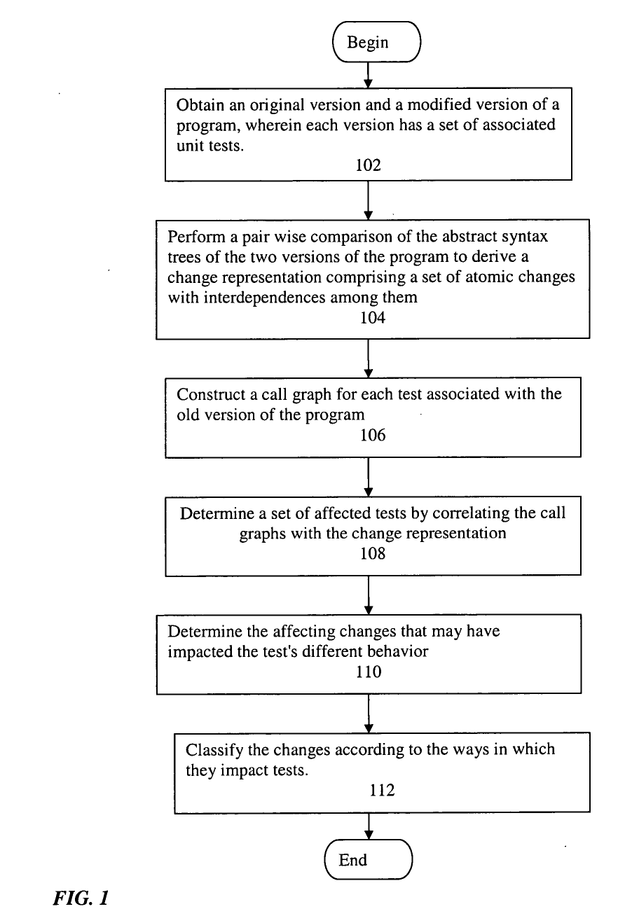

Referring to FIG. 1, we describe a method according to an embodiment of the invention performed with an information processing system suitably configured. In step 102 the system receives two versions of a program that is written in an object-oriented programming language such as Java. The versions comprise an original program and a modified version. Associated with each version is a set of tests (unit tests or regression tests). In step 104 the system performs a pair-wise comparison of the abstract syntax trees of the two versions of the program to derive a change representation that consists of a set of atomic changes with interdependences among the changes. In step 106, the system constructs a call graph for each test associated with the old version of the program. Then in step 108, by correlating the call graphs with the change representation, a set of affected tests is determined. Informally, a test is deemed affected if its execution behavior may be different as a result of the applied changes. Any test that is not affected is guaranteed to have the same behavior as before (here, the usual assumptions about the absence of nondeterminism and identical inputs are made). For each test that is affected, the system can construct the call graph for that test in the new version of the program. Correlating this new call graph with the change representation serves to determine the affecting changes that may have impacted the test's different behavior. Any change that is not in the identified set of affecting changes is guaranteed not to be related to the test's changed behavior.

We accomplish an improvement over the prior art in step 112 at least by classifying the changes according to the ways in which they impact tests. To this end, we capture the result of each test in both versions of the program. These results are elements of a set: {success, failure, exception}. Then, for each change we determine the set of tests for which it occurs in the set of affecting changes. The classification is based on the old and new results for each of the tests that it affects.

In one embodiment, we use different colors to classify changes. For example, consider a change C that affects only a set of tests that succeed in the old version. If these tests all succeed in the new version, we classify C as “GREEN.” If these tests all fail in the new version, we classify C as “RED.” Otherwise, we classify C as “YELLOW.” This classification scheme helps programmers quickly identify those changes that have caused test failures.

The change classification scheme discussed herein presumes the existence of a suite T of regression tests associated with a Java program and access to the original and edited versions of the code.

A method according to another embodiment comprises the following steps: (1) A source code edit is analyzed to obtain a set of interdependent atomic changes S, whose granularity is (roughly) at the method level. These atomic changes include all possible effects of the edit on dynamic dispatch. (2) Then, a call graph is constructed for each test in T. Our method can use either dynamic call graphs that have been obtained by tracing the execution of the tests, or static call graphs that have been constructed by a static analysis engine. Dynamic call graphs were used in Ren, X., Shah, F., Tip, F., Ryder, B. G., Chesley, O., Chianti: a tool for change impact analysis of Java programs. In Proceedings of the 19th Annual ACM SIGPLAN Conference on Object-Oriented Programming, Systems, Languages, and Applications, (OOPSLA 2004), Vancouver, BC, Canada, October 2004, pp. 432-448 (Ren et al. 2004) and static call graphs were used in Ren, X., Shah, F., Tip, F., Ryder, B. G., Chesley, O., and Dolby, J., Chianti: A prototype change impact analysis tool for Java. Tech. Rep. DCS-TR-533, Rutgers University Department of Computer Science, September 2003 (Ren et al 2003). (3) For a given set T of regression tests, the analysis determines a subset T′ of T that is potentially affected by the changes in S, by correlating the changes in S against the call graphs for the tests in T in the original version of the program. (4) Then, for a given test tᵢ in T′, the analysis can determine a subset S′ of S that contains all the changes that may have affected the behavior of tᵢ. This is accomplished by constructing a call graph for tᵢ in the edited version of the program, and correlating that call graph with the changes in S. (5) Finally, the changes are classified by taking into account the result of the tests that they affect in both versions of the program. For example, consider a change C that affects only a set of tests that succeed in the old version. If these tests all succeed in the new version, we classify C as “GREEN”. If these tests all fail in the new version, we classify C as “RED”. Otherwise, we classify C as “YELLOW.”

This classification helps programmers quickly identify those changes that have caused test failures. This method provides programmers with tool support that can help them understand why a test is suddenly failing after a long editing session by isolating the changes responsible for the failure.

There are important differences between the embodiments discussed herein and previous work on regression test selection and change impact analysis. Step (3) above, unlike previous approaches does not rely on a pairwise comparison of high-level program representations such as control flow graphs (see, e.g. Rothermel, G., and Harrold, M. J., A safe, efficient regression test selection technique. ACM Trans. on Software Engineering and Methodology 6, 2 (April 1997), 173-210)) or Java InterClass Graphs. See Harrold, M. J., Jones, J. A., Li, T., Liang, D., Orso, A., Pennings, M., Sinha, S., Spoon, S. A., and Gujarathi, A., Regression test selection for Java software. In Proc. of the ACM SIGPLAN Conf. on Object Oriented Programming Languages and Systems (OOPSLA'01) (October 2001), pp. 312-326.

The embodiments discussed herein differ from other approaches for dynamic change impact analysis such as: Law and Rothermel; Orso et al 2003; and Orso, et al 2004, in the sense that these approaches are primarily concerned with the problem of determining a subset of the methods in a program that were affected by a given set of changes. In contrast, step 4 (above) of the present embodiment is concerned with the problem of isolating a subset of the changes that affect a given test. In addition, our approach decomposes the code edit into a set of semantically meaningful, interdependent “atomic changes” which can be used to generate intermediate program versions, in order to investigate the cause of unexpected test behavior.

### 1.1. Overview

We now provide an informal overview of the change impact analysis methodology originally presented in Ryder and Tip 2001. That method determines, given two versions of a program and a set of tests that execute parts of the program, the affected tests whose behavior may have changed. The method is safe in the sense that this set of affected tests contains at least every test whose behavior may have been affected. See Rothermel, G., and Harrold, M. J., A safe, efficient regression test selection technique. ACM Trans. on Software Engineering and Methodology 6, 2 (April 1997), 173-210.

Then, in a second step, for each test whose behavior was affected, a set of affecting changes is determined that may have given rise to that test's changed behavior. Our method is conservative in the sense that the computed set of affecting changes is guaranteed to contain at least every change that may have caused changes to the test's behavior.

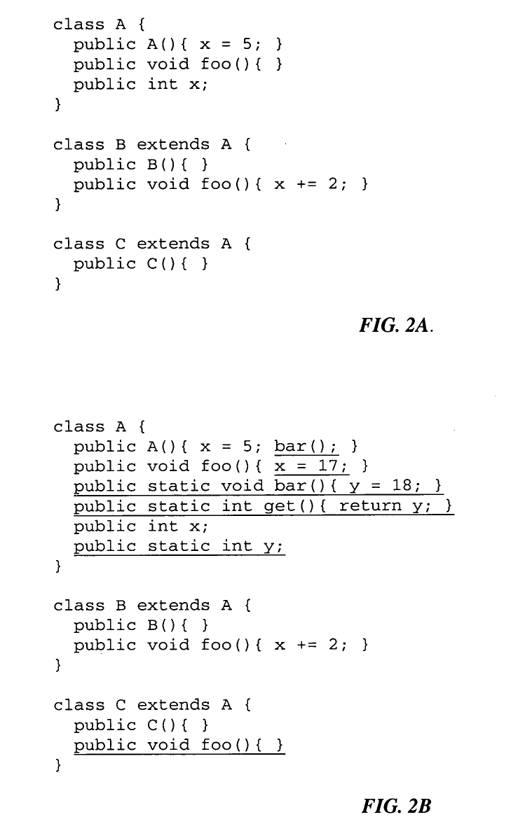

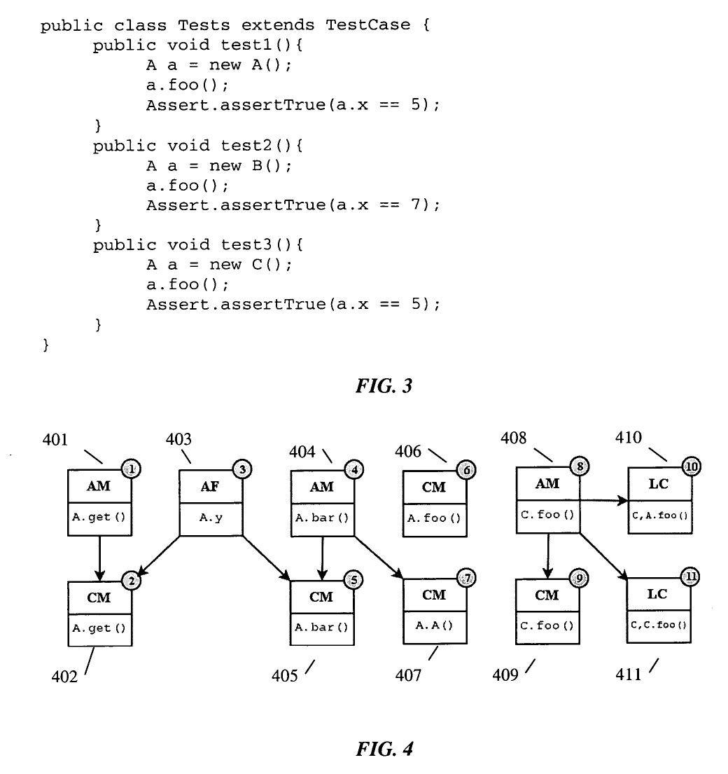

We will use the example program of FIG. 2A to illustrate our approach. The program of FIG. 2A depicts a simple program comprising classes A, B, and C. FIG. 2B shows an edited version of the program, where the changes are shown using underlining. Associated with the program are three tests, Tests.test1( ), Tests.test2( ), and Tests.test3( ), which are shown in FIG. 3.

Our change impact analysis relies on the computation of a set of atomic changes that capture all source code modifications at a semantic level that is amenable to analysis. We use a fairly coarse-grained model of atomic changes, where changes are categorized as added classes (AC), deleted classes (DC), added methods (AM), deleted methods (DM), changed methods (CM), added fields (AF), deleted fields (DF), and lookup (i.e., dynamic dispatch) changes (LC). There are a few more categories of atomic changes that are not relevant for the example under consideration that will be presented herein.

We also compute syntactic dependences between atomic changes. Intuitively, an atomic change A1 is dependent on another atomic change A2 if applying A1 to the original version of the program without also applying A2 results in a syntactically invalid program (i.e., A2 is a prerequisite for A1). These dependences can be used to determine that certain changes are guaranteed not to affect a given test, and to construct syntactically valid intermediate versions of the program that contain some, but not all atomic changes. It is important to understand that the syntactic dependences do not capture semantic dependences between changes (consider, e.g., related changes to a variable definition and a variable use in two different methods). This means that if two atomic changes, C1 and C2, affect a given test t, then the absence of a syntactic dependence between C1 and C2 does not imply the absence of a semantic dependence; that is, program behaviors resulting from applying C1 alone, C2 alone, or C1 and C2 together, may all be different. If a set S of atomic changes is known to expose a bug, then the knowledge that applying certain subsets of S does not lead to syntactically valid programs, can be used to localize bugs more quickly.

FIG. 4 shows the atomic changes that define the two versions of the example program, numbered 1 through 11 (401-411, respectively) for convenience. Each atomic change is shown as a box, where the top half of the box shows the category of the atomic change (e.g., CM for changed method), and the bottom half shows the method or field involved (for LC changes, both the class and method involved are shown). An arrow from an atomic change A1 to an atomic change A2 indicates that A2 is dependent on A1. Consider, for example, the addition of the call to method bar( ) in method A.A( ). This source code change resulted in atomic change 7 in FIG. 4. Observe that adding this call would lead to a syntactically invalid program unless method A.bar( ) is also added. Therefore, atomic change 7 is dependent on atomic change 4, which is an AM change for method A.bar( ). The observant reader may have noticed that there is also a CM change for method A.bar( ) (atomic change 5). This is the case because our method for deriving atomic changes decomposes the source code change of adding method A.bar( ) into two steps: the addition of an empty method A.bar( ) (AM atomic change 4 in the figure), and the insertion of the body of method A.bar( ) (CM atomic change 5 in the figure), where the latter is dependent on the former. Notice that our model of dependences between atomic changes correctly captures the fact that adding the call to bar( ) requires that an (empty) method A.bar( ) is added, but not that the field A.y is added.

The LC atomic change category models changes to the dynamic dispatch behavior of instance methods. In particular, an LC change (Y,X.m( )) models the fact that a call to method X.m( ) on an object of type Y results in the selection of a different method. Consider, for example, the addition of method C.foo( ) to the program of FIG. 2A.

As a result of this change, a call to A.foo( ) on an object of type C will dispatch to C.foo( ) in the edited program, whereas it used to dispatch to A.foo( ) in the original program. This change in dispatch behavior is captured by atomic change 10. LC changes are also generated in situations where a dispatch relationship is added or removed as a result of a source code change. (Other scenarios that give rise to LC changes will be discussed below). For example, atomic change 11 (defining the behavior of a call to C.foo( ) on an object of type C) occurs due to the addition of method C.foo( ).

In order to identify those tests that are affected by a set of atomic changes, we have to construct a call graph for each test. The call graphs used in this embodiment contain one node for each method, and edges between nodes to reflect calling relationships between methods. Our analysis can work with call graphs that have been constructed using static analysis, or with call graphs that have been obtained by observing the actual execution of the tests.

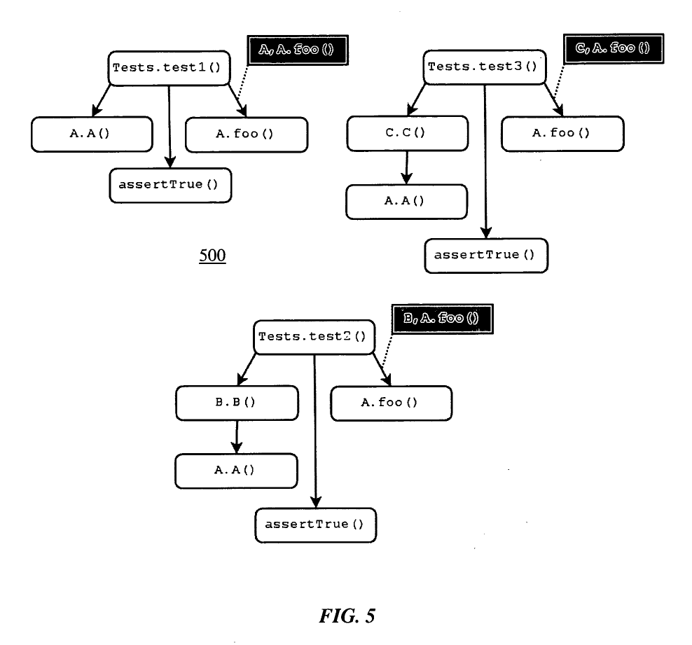

FIG. 5 shows the call graphs for the three tests: test1; test2; and test3, before the changes have been applied. In these call graphs, edges corresponding to dynamic dispatch are labeled with a pair <T,M>, where T is the run-time type of the receiver object, and M is the method shown as invoked at the call site. A test is determined to be affected if its call graph (in the original version of the program) either contains a node that corresponds to a changed method CM or deleted method DM change, or if its call graph contains an edge that corresponds to a lookup change LC. Using the call graphs in FIG. 5, it is easy to see that test1, test2, and test3 are all affected because their call graphs each contain a node for A.A( ), which corresponds to CM change 7.

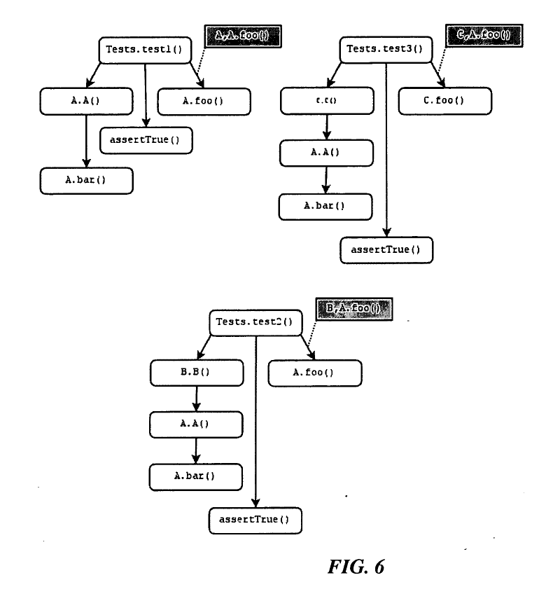

In order to compute the changes that affect a given affected test, we need to construct a call graph for that test in the edited version of the program. These call graphs for the tests are shown in FIG. 6. The set of atomic changes that affect a given affected test includes: (i) all atomic changes for added methods (AM) and changed methods (CM) that correspond to a node in the call graph (in the edited program), (ii) atomic changes in the lookup change (LC) category that correspond to an edge in the call graph (in the edited program), and (iii) their transitively prerequisite atomic changes.

The affecting changes for test1 can be computed as follows. Observe, that the call graph for test1 in FIG. 6 contains methods A.A( ), A.bar( ), and A.foo( ). These nodes correspond to atomic changes 7, 5, and 6 in FIG. 4, respectively. From the dependence arrows in FIG. 4, it can be seen that atomic change 7 requires atomic change 4, and atomic change 5 requires atomic changes 3 and 4. Therefore, the atomic changes affecting test1 are 3, 4, 5, 6, and 7.

The affecting changes for test2 can be computed as follows. Observe, that the call graph for test2 in FIG. 6 contains methods A.A( ) and A.bar( ). These nodes correspond to atomic changes 7, and 5 in FIG. 4, respectively. From the dependence arrows in FIG. 4, it can be seen that atomic change 7 requires atomic change 4, and atomic change 5 requires atomic changes 3 and 4. Therefore, the atomic changes affecting test1 are 3, 4, 5 and 7.

The affecting changes for test3 can be computed as follows. Observe, that the call graph for test3 in FIG. 6 contains methods A.A( ), A.bar( ) and C.foo( ), and an edge labeled “C, A.foo( )”. Node A.A( ) corresponds to atomic change 7, which is dependent on atomic change 4, and node A.bar( ) corresponds to atomic change 5, which is dependent on atomic changes 3 and 4. Node C.foo( ) corresponds to atomic change 9, which is dependent on atomic change 8. Finally, the edge labeled “C, A.foo( )” corresponds to atomic change 10, which is also dependent on atomic change 8. Consequently, test3 is affected by atomic changes 3, 4, 5, 7, 8, 9, and 10.

Observe that atomic changes 1 and 2 (corresponding to the addition of method A.get( )) and 11 (corresponding to a call to C.foo( ) on an object of type C) do not correspond to any node or edge in any of the call graphs. These changes are not covered by any tests, and provide an indication that additional tests are needed.

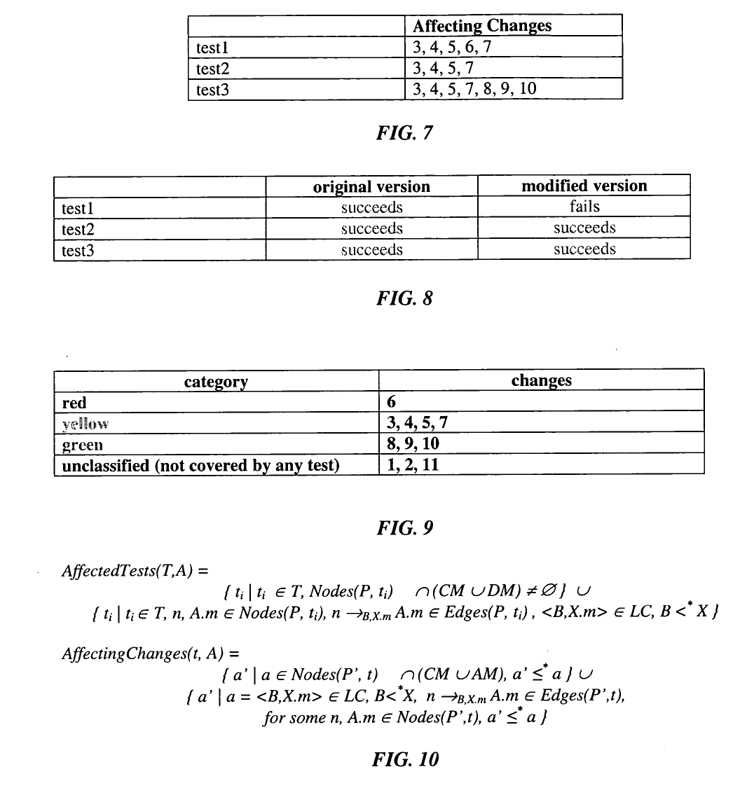

FIG. 7 shows the affecting changes for each of the tests. We will use the equations in FIG. 10 (taken from Ryder and Tip 2001) to more formally define how we find affected tests and their corresponding affecting atomic changes, in general. Assume the original program P is edited to yield program P′, where both P and P′ are syntactically correct and compilable. Associated with P is a set of tests T={t₁, . . . , tₙ}. The call graph for test tᵢ on the original program, called Gₜᵢ, is described by a subset of P's methods Nodes(P,tᵢ) and a subset Edges(P, tᵢ) of calling relationships between P's methods. Likewise, Nodes(P′,tᵢ) and Edges(P′,tᵢ) form the call graph G′ₜᵢ on the edited program P′. Here, a calling relationship is represented as D.n( ) δB,X.m( ) A.m( ), indicating possible control flow from method D.n( ) to method A.m( ) due to a virtual call to method X.m( ) on an object of type B. We implicitly make the usual assumptions that program execution is deterministic and that the library code used and the execution environment (e.g., JVM) itself remain unchanged. See Harrold, M. J., Jones, J. A., Li, T., Liang, D., Orso, A., Pennings, M., Sinha, S., Spoon, S. A., and Gujarathi, A., Regression test selection for Java software. In Proc. of the ACM SIGPLAN Conf on Object Oriented Programming Languages and Systems (OOPSLA'01) (October 2001), pp. 312-326.

FIG. 8 shows the result of running the three tests against the old version of the program and against the new version of the program: the program initially passes all tests, but test1 fails in the new version of the program. As FIG. 4 shows, there are eleven atomic changes, and the question is now: Which of those eleven changes is the likely reason for the test failure? We provide an answer to this question by classifying the changes according to the tests that they affect. To a first approximation, this classification works as follows:

A change that affects only tests that succeed in both versions of the program is classified as “green”.

A change that affects only tests that succeed in the original version of the program, but that fail in the modified version of the program is classified as “red”.

A change that affects both (i) tests that succeed in both versions of the program, and (ii) tests that succeed in the original version but that fail in the modified version is classified as “yellow”.

Intuitively, red changes are most likely to be the source of the error, followed by yellow changes, and green changes.

FIG. 9 shows the result of the change classification. Atomic change 6 is the only change classified as “red” because it affects test1 (a test that succeeds in the old version but fails in the new version of the program) and no other tests. Changes 8, 9, and 10 are classified as green because they only affect a test that succeeds in both versions of the program. Changes 3, 4, 5, and 7 are classified as “yellow” because they impact test1, as well as a succeeding test. Change 6 is clearly the source of the assertion failure in the new version of test1, so our method has correctly identified the change responsible for this problem.

We should note that the example we discussed only illustrates a few of the scenarios that may arise. For example, we did not discuss the scenario where a test failed in the original version of the program, and succeeded in the modified version. The classification mechanism can be extended to encompass this scenario as well. It should also be pointed out here that finer-grained classification mechanisms such as those that distinguish different sources of failures (e.g., assertion failures vs. exceptions) can be modeled similarly.

### 2. Atomic Changes and Their Dependences

As previously mentioned, a key aspect of our analysis is the step of uniquely decomposing a source code edit into a set of interdependent atomic changes. In the original formulation, several kinds of changes, (e.g., changes to access rights of classes, methods, and fields and addition/deletion of comments) were not modeled. See Ryder, B. G., and Tip, F., Change impact for object oriented programs. In Proc. of the ACM SIGPLAN/SIGSOFT Workshop on Program Analysis and Software Testing (PASTE01) (June 2001)(Ryder and Tip 2001). Section 2.1 discusses how these changes are handled.

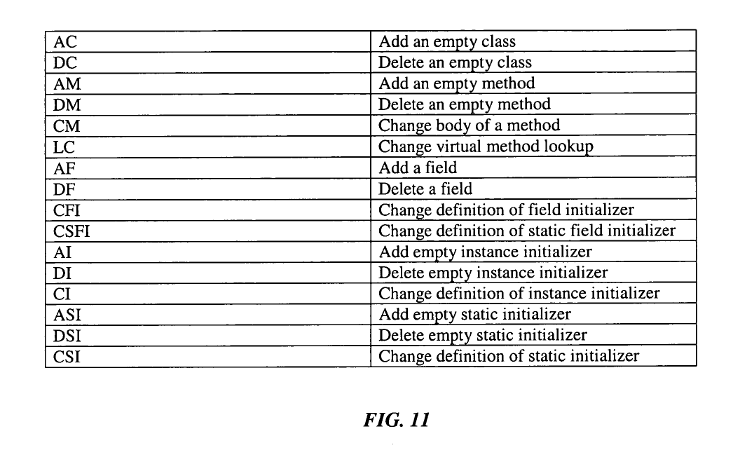

FIG. 11 lists the set of atomic changes employed, which includes the original eight categories (See Ryder and Tip June 2001) plus eight new atomic changes presented in Ren, X., Shah, F., Tip, F., Ryder, B. G., Chesley, O., Chianti: a tool for change impact analysis of Java programs. In Proceedings of the 19th Annual ACM SIGPLAN Conference on Object-Oriented Programming, Systems, Languages, and Applications, (OOPSLA 2004), Vancouver, BC, Canada, October 2004, pp. 432-448 (Ren et al 2004) (the bottom eight rows of the table). Most of the atomic changes are self-explanatory except for CM and LC. CM represents any change to a method's body. Some extensions to the original definition of CM are discussed in detail in Section 2.1. LC represents changes in dynamic dispatch behavior that may be caused by various kinds of source code changes (e.g., by the addition of methods, by the addition or deletion of inheritance relations, or by changes to the access control modifiers of methods). LC is defined as a set of pairs <Y, X.m( )>, indicating that the dynamic dispatch behavior for a call to X.m( ) on an object with run-time type Y has changed.

### 2.1 New and Modified Atomic Changes

The method described in this document was implemented in a tool called Chianti. Chianti handles the full Java programming language, which necessitated the modeling of several constructs not considered in the original framework. See Ryder and Tip 2001. Some of these constructs required the definition of new sorts of atomic changes; others were handled by augmenting the interpretation of atomic changes already defined.

### Initializers, Constructors, and Fields

Six of the newly added changes in FIG. 11 correspond to initializers. A1 and DI denote the set of added and deleted instance initializers respectively, and ASI and DSI denote the set of added and deleted static initializers, respectively. CI and CSI capture any change to an instance or static initializer, respectively. The other two new atomic changes, CFI and CSFI, capture any change to an instance or static field, including (i) adding an initialization to a field, (ii) deleting an initialization of a field, (iii) making changes to the initialized value of a field, and (iv) making changes to a field modifier (e.g., changing a static field into a non-static field).

Changes to initializer blocks and field initializers also have repercussions for constructors or static initializer methods of a class. Specifically, if changes are made to initializers of instance fields or to instance initializer blocks of a class C, then there are two cases: (i) if constructors have been explicitly defined for class C, then Chianti will report a CM for each such constructor, (ii) otherwise, Chianti will report a change to the implicitly declared method C.<init> that is generated by the Java compiler to invoke the superclass's constructor without any arguments. Similarly, the class initializer C.<clinit> is used to represent the method being changed when there are changes to a static field (i.e., CSFI) or static initializer (i.e., CSI).

### Overloading

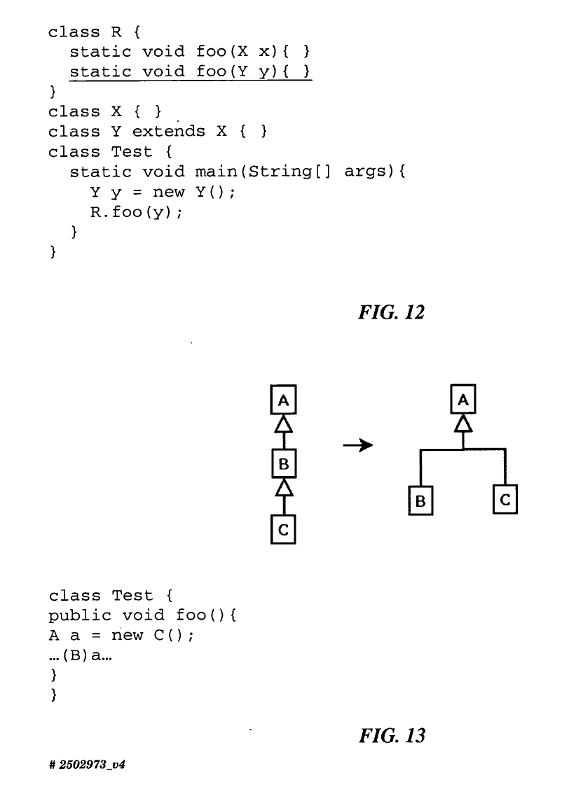

Overloading poses interesting issues for change impact analysis. Consider the introduction of an overloaded method as shown in FIG. 12 (the added method is shown underlined). Note that there are no textual edits in Test.main( ), and further, that there are no LC changes because all the methods are static. However, adding method R.foo(Y) changes the behavior of the program because the call of R.foo(y) in Test.main( ) now resolves to R.foo(Y) instead of R.foo(X). See Gosling, J., Joy, B., Steele, G., and Bracha, G., The Java Language Specification (Second Edition).Addison-Wesley, 2000(Gosling et al 2000). Therefore, Chianti must report a CM change for method Test.main( ) despite the fact that no textual changes occur within this method (However, the abstract syntax tree for Test.main( ) will be different after applying the edit, as overloading is resolved at compile time.)

### Hierarchy Changes

It is also possible for changes to the hierarchy to affect the behavior of a method, although the code in the method is not changed. Various constructs in Java such as instance of, casts and exception catch blocks test the run-time type of an object. If such a construct is used within a method and the type lies in a different position in the hierarchy of the program before the edit and after the edit, then the behavior of that method may be affected by this hierarchy change (or restructuring). For example, in FIG. 13, method foo( ) contains a cast to type B. This cast will succeed if the type of the object pointed to by a when execution reaches this statement is B or C in the original program. In contrast, if we make the hierarchy change shown, then this cast will fail if the run-time type of the object which reaches this statement is C. Note that the code in method foo( ) has not changed due to the edit, but the behavior of foo( ) has been possibly altered. To capture these sorts of changes in behavior due to changes in the hierarchy, we report a CM change for the method containing the construct that checks the run-time type of the object (i.e., CM(Test.foo( ))).

### Threads and Concurrency

Threads do not pose significant challenges for our analysis. The addition/deletion of synchronized blocks inside methods and the addition/deletion of synchronized modifiers on methods are both modeled as CM changes. Threads do not present significant issues for the construction of call graphs either, because the analysis discussed herein does not require knowledge about the particular thread that executes a method. The only information that is required are the methods that have been executed and the calling relationships between them. If dynamic call graphs are used, as is the case in this embodiment, this information can be captured by tracing the execution of the tests. If flow-insensitive static analysis is used for constructing call graphs, the only significant issue related to threads is to model the implicit calling relationship between Thread.start( ) and Thread.run( ). See Ren et al. 2003.

### Exception Handling

Exception handling constructs do not raise significant issues for our analysis. Any addition or deletion or statement-level changes to a try, catch or finally block will be reported as a CM change. Similarly, changes to the throws clause in a method declaration are also captured as CM changes. Possible interprocedural control flow introduced by exception handling is expressed implicitly in the call graph; however, our change impact analysis correctly captures effects of these exception-related code changes. For example, if a method f( ) calls a method g( ), which in turn calls a method h( ) and an exception of type E is thrown in h( ) and caught in g( ) before the edit, but in f( ) after the edit, then there will be CM changes for both g( ) and f( ) representing the addition and deletion of the corresponding catch blocks. These CM changes will result in all tests that execute either f( ) or g( ) to be identified as affected. Therefore, all possible effects of this change are taken into account, even without the explicit representation of flow of control due to exceptions in our call graphs.

### Changes to CM and LC

Accommodating method access modifier changes from non-abstract to abstract or vice-versa, and non-public to public or vice-versa, required extension of the original definition of CM. CM now comprises: (i) adding a body to a previously abstract method, (ii) removing the body of a non-abstract method and making it abstract, or (iii) making any number of statement-level changes inside a method body or any method declaration changes (e.g., changing the access modifier from public to private, adding a synchronized keyword or changing a throws clause). In addition, in some cases, changing a method's access modifier results in changes to the dynamic dispatch in the program (i.e., LC changes). For example, there is no entry for private or static methods in the dynamic dispatch map (because they are not dynamically dispatched), but if a private method is changed into a public method, then an entry will be added, generating an LC change that is dependent on the access control change, which is represented as a CM. Additions and deletions of import statements may also affect dynamic dispatch and are handled by Chianti.

### 2.2 Dependences

Atomic changes have interdependences which induce a partial ordering <on a set of them, with transitive closure <*. Specifically, C1<*C2 denotes that C1 is a prerequisite for C2. This ordering determines a safe order in which atomic changes can be applied to program P to obtain a syntactically correct edited version P″ which, if we apply all the changes is P′. Consider that one cannot extend a class X that does not yet exist, by adding methods or fields to it (i.e., AC(X)<AM(X.m( )) and AC(X)<AF(X.f)). These dependences are intuitive as they involve how new code is added or deleted in the program. Other dependences are more subtle. For example, if we add a new method C.m( ) and then add a call to C.m( ) in method D.n( ), there will be a dependence AM(C.m( ))<CM(D.n( )). FIG. 4 shows some examples of dependences among atomic changes.

Dependences involving LC changes can be caused by edits that alter inheritance relations. LC changes can be classified as (i) newly added dynamic dispatch tuples (e.g., caused by declaring a new class/interface or method), (ii) deleted dynamic dispatch tuples (e.g., caused by deleting a class/interface or method), or (iii) dynamic dispatch tuples with changed targets (e.g., caused by adding/deleting a method or changing the access control of a class or method). For example, making an abstract class C non-abstract will result in LC changes. In the original dynamic dispatch map, there is no entry with C as the run-time receiver type, but the new dispatch map will contain such an entry. Similar dependences result when other access modifiers are changed.

### 3. Change Classification and Determining Committable Changes

This section describes how changes are classified to reflect their possible effects on system semantics. The goal of this classification is to allow programmers to determine whether or not the changes they made were correct, by relating changes with test results.

### 3.1 Change Classification

The change classification introduced below reflects the test result model of JUnit tests, where three different test results are possible: a test can pass, fail (if the actual outcome does not match the expected outcome) or crash (an exception is caught by the JUnit runtime). However, even if a different testing framework is used (either one that uses a single error state, or one that uses even more error states), this classification can easily be adapted if necessary.

The following notation will be used. Let C be the set of atomic changes, and cεC be an atomic change. Let T(c) be the set of tests affected by c. Let L(t)ε{NEW, PASS, FAIL, ER\dot{R}} be the last test result and C(t)ε{PASS, FAIL, ERR} be the current test result.

In general test results can be classified roughly into “success” and “failure” test results. For a test t we assume predicates is Success(t) and is Failure(t) to be defined for possible test results. For JUnit, is Success(t) returns true if C(t)=PASS, and false otherwise, and, is Failure(t) returns true if C(t)ε{ERR, FAIL}, and false otherwise.

Change classification is based on the development of test results over time. A test result can improve, worsen or remain unchanged. Based on this observation we associate tests with changes to classify changes in such a way that assists developers with finding newly introduced bugs.

We first introduce an auxiliary classification of test results:

Worsening tests: tεWT: [symbol] is Success(L(t)) and is Failure(C(t))

Improving tests: tεIT [symbol] is Failure(L(t)) and is Success}(C(t))

Unchanged (don't care) tests: tεDCT [symbol] t∉WT and t∉IT

Note that the above test classification defines a partition, as a test cannot be in IT and WT at the same time and all tests not classified as either worsening or improving are classified as DCT. So each test is classified in exactly one category. The subsequent change classification is based on the resulting sets and valid whatever classification is used here, as long as it still partitions the test sets. So for a different test result setup, another test classification can be used. By using T(c), we can now associate classified tests with changes.

Using the following functions, the affected tests for a given change c are partitioned as follows:

Worsening tests per change: WTC(c)=WT∩T(c)

Improving tests per change: ITC(c)=IT∩T(c)

Unchanged (don't care) tests per change: DCTC(c)=DCT∩T(c)

This allows one to classify all affected tests for a single change. Based on this classification we now classify changes as follows: An atomic change c is classified as follows using the sets WTC(c), ITC(c) and DCTC(c) and the predicates is Successful and is Failure:

GREEN changes indicate changes complying to all tests: cεGREEN if for all tεT(c) we have that tε(ITC(c)∪{DCTC(c): is Successful(C(t))})

RED changes indicate definitely problematic changes: cεRED [symbol] WTC(c)≠Ø and for all tεT(c) we have that t∉ITC(c)

YELLOW changes are potentially problematic, a definitive statement about these changes is not possible: cεYELLOW [symbol] (ITC(c)≠Ø and WTC(c)≠Ø) or (WTC(c)=Ø and there exists a tεDCTC(c) such that is Failure(C(t)))

GRAY changes are changes not affecting any test, i.e. untested changes: cεGRAY [symbol] T(c)=Ø

The intuition for these change categories is that for GREEN changes, all affected tests succeed (regardless of the prior results for these tests). RED changes are the exact opposite and are “definitely problematic”. A RED change does not contribute to any improved test result, and at least one test result has become worse as a result of it.

In general, there might be changes that improve some results but worsen others. These changes are categorized as YELLOW, outlining them as “possibly problematic”. The programmer still has to study yellow changes in detail to figure out if the change works as expected. However, the task to find the worsening tests for a YELLOW change can be automated using the change classification WTC(c).

Note that unchanged test results also influence change classification. We classify changes that affect failing unchanged tests as YELLOW, because such tests may now fail (additionally) as a result as a result of the changes that affected it.

Besides these three major change categories, we classify a change as GRAY, if it has no affected tests (i.e., T(c)=Ø). This is more a coverage issue than a debugging support issue. However, such information is nonetheless important, as it indicates that the test suite is not sufficient and should be expanded to also cover GRAY changes.

### 3.2 Determining Committable Changes.

Classifying changes can be helpful to narrow down the potential reasons for failures, and thus assist programmers in finding bugs in their programs. But change classification can also be exploited for a different purpose, namely to reduce time intervals between releases of changes to a repository.

In what follows, we assume that the following commit policy is used: Changes may only be committed when all tests pass. This policy is commonly used and has the obvious advantage that the repository version does not contain any newly introduced bugs that are due to functionality checked by the test suite.

However, consider the following scenario. Assume we develop a system S, with a large associated test suite T, which requires overnight runs. As a result, programmers only become aware of bugs the next morning, and if bugs are revealed by the overnight run, their changes cannot be committed because bugs have to be fixed first. Although individual tests might be rerun quickly, the entire test suite will only be rerun overnight, so the changes will not be released until the next day (unless more bugs are revealed). The test suite could also be rerun immediately, but this also costs time.

Although there are some problematic changes causing tests to fail, most of the changes do not affect the failing tests and could be committed without violating the commit policy. We can use the different categories of changes, as base information to construct the set of committable changes.

To determine the changes that can be committed safely, dependencies among changes have to be taken into account. For example, we cannot classify a change c1 as committable if it depends on a RED change c2, because the former cannot be applied without the latter, and the latter causes a test failure. We therefore define the set C_{committable} of all strict committable changes as follows. Let c be a change. Then: cεC_{committable} if and only if: (i) forall tεT(c) we have that C(t)=PASS, and (ii) forall c′ such that c′≦*c we have that c′εC_{committable}.

We also present an alternative, more relaxed definition of committable changes that is based on the following, alternative commit policy: Don't commit any change that makes any test results worse. We define the set C_{R-committable} of relaxed committable changes as follows. Let c be a change. Then cεC_{R-committable} if and only if: (i) WTC(c)=Ø and (ii) for all c′ such that c′≦*c we have that c′εC_{R-committable}.

In general, the definition of CR-committable yields a bigger set of committable changes, as it also includes changes affecting tests t with C(t)=L(t)ε{FAIL, ERR} which are excluded by Ccommittable.

Note that both definitions (Ccommittable and CR-committable) consider changes that are not covered by any test to be committable. To justify this, consider an environment where programmers are not the people writing the tests. Then, the testing team has to anticipate the changes made by the programmers, which is best achieved by releasing (initially failing) tests to the repository.

If a set of changes has been classified as not committable (compared to the last repository version), one can imagine comparing the current version of the program to the latest version in the repository and providing a feature to automatically roll back all non-committable changes to create an intermediate, committable version. This feature would obviously be very useful in an extreme programming development model where code is quickly changed to test a possible implementation for a new feature. Working code then can be kept, changes breaking necessary functionality can be undone, regardless of the temporal order in which these changes were made.

### 4. Related Methods

We distinguish three broad categories of related methods in the community: (i) change impact analysis techniques, (ii) regression test selection techniques, and (iii) techniques for controlling the way changes are made. See Ryder and Tip 2001 and Ren et al. 2003.

### 4.1 Change Impact Analysis Techniques

Previous research in change impact analysis has varied from approaches relying completely on static information, including the early analyses of Bohner and Arnold (2001) and Kung et al (1994) to approaches that only use dynamic information such as Law and Rothermel (2003). See Kung, D.C., Gao, J., Hsia, P., Wen, F., Toyoshima, Y., and Chen, C., Change impact identification in object oriented software maintenance. In Proc. of the International Conf. on Software Maintenance (1994), pp. 202-211.

There also are some methods that use a combination of static and dynamic information. See Orso, A., Apiwattanapong, T., and Harrold, M. J., Leveraging field data for impact analysis and regression testing. In Proc. of European Software Engineering Conf and ACM SIGSOFT Symp. on the Foundations of Software Engineering (ESEC/FSE'03) (Helsinki, Finland, September 2003).

The method described in this embodiment is a combined approach, in that it uses (i) static analysis for finding the set of atomic changes comprising a program edit and (ii) dynamic call graphs to find the affected tests and their affecting changes.

All prior impact analyses focus on finding constructs of the program potentially affected by code changes. In contrast, our change impact analysis aims to find a subset of the changes that impact a test whose behavior has (potentially) changed. First we will discuss the previous static techniques and then address the combined and dynamic approaches.

An early form of change impact analysis used reachability on a call graph to measure impact. This technique (This is only one of the static change impact analyses discussed.) was presented by Bohner and Arnold as “intuitively appealing” and “a starting point” for implementing change impact analysis tools. However, applying the Bohner-Arnold technique is not only imprecise but also unsound, because, by tracking only methods downstream from a changed method, it disregards callers of that changed method that can also be affected.

Kung, et al, (1994), supra pp. 202-211 described various sorts of relationships between classes in an object relation diagram (i.e., ORD), classified types of changes that can occur in an object-oriented program, and presented a technique for determining change impact using the transitive closure of these relationships. Some of our atomic change types partially overlap with their class changes and class library changes.

Tonella's impact analysis determines if the computation performed on a variable x affects the computation on another variable y using a number of straightforward queries on a concept lattice that models the inclusion relationships between a program's decomposition (static) slices. See see Tonella, P., Using a concept lattice of decomposition slices for program understanding and impact analysis. IEEE Trans. on Software Engineering 29, 6 (2003), 495-509); and Gallagher, K., and Lyle, J. R. Using program slicing in software maintenance. IEEE Trans. on Software Engineering 17 (1991). Tonella reports some metrics of the computed lattices, but gives no assessment of the usefulness of his techniques.

A number of tools in the Year 2000 analysis domain use type inference to determine the impact of a restricted set of changes (e.g., expanding the size of a date field) and perform them if they can be shown to be semantics-preserving. See Eidorff, P. H., Henglein, F., Mossin, C., Niss, H., Sorensen, M. H., and Tofte, M. Anno Domini: From type theory to year 2000 conversion. In Proc. of the ACM SIGPLAN-SIGACT Symp. on Principles of Programming Languages (January 1999), pp. 11-14, Ramalingam, G., Field, J., and Tip, F., Aggregate structure identification and its application to program analysis. In Proc. of the ACM SIGPLAN-SIGACT Symp. on Principles of Programming Languages (January 1999), pp. 119-132.

Thione et al. wish to find possible semantic interferences introduced by concurrent programmer insertions, deletions or modifications to code maintained with a version control system. See Thione, G. L., and Perry, D. E., Parallel changes: Detecting semantic interference. Tech. Rep. ESEL-2003-DSI-1, Experimental Software Engineering Laboratory, University of Texas, Austin, September 2003, Thione, G. L., Detecting semantic conflicts in parallel changes, December 2002. Masters Thesis, Department of Electrical and Computer Engineering, University of Texas, Austin. In this work, a semantic interference is characterized as a change that breaks a def-use relation. Their unit of program change is a delta provided by the version control system, with no notion of subdividing this delta into smaller units, such as our atomic changes. Their analysis, which uses program slicing, is performed at the statement level, not at the method level as in Chianti. No empirical experience with the algorithm is given.

The CoverageImpact change impact analysis technique by Orso et al. uses a combined methodology, by correlating a forward static slice with respect to a changed program entity (i.e., a basic block or method) with execution data obtained from instrumented applications. See Orso, A., Apiwattanapong, T., and Harrold, M.J., Leveraging field data for impact analysis and regression testing. In Proc. of European Software Engineering Conf. and ACM SIGSOFT Symp. on the Foundations of Software Engineering (ESEC/FSE'03) (Helsinki, Finland, September 2003); and Tip, F., A survey of program slicing techniques. Journal of Programming Languages 3, 3 (1995), 121-189. Each program entity change is thusly associated with a set of possibly affected program entities. Finally, these sets are unioned to form the full change impact set corresponding to the program edit.

There are a number of important differences between the present embodiment and Orso et al. First, the methods differ in the goals of the analysis. The method of Orso et al. is focused on finding those program entities that are possibly affected by a program edit. In contrast, our method is focused on finding those changes that caused the behavioral differences in a test whose behavior has changed. Second, the granularity of change expressed in their technique is a program entity, which can vary from a basic block to an entire method. In contrast, we use a richer domain of changes more familiar to the programmer, by taking a program edit and decomposing it into interdependent, atomic changes identified with the source code (e.g., add a class, delete a method, add a field). Third, their technique is aimed at deployed codes, in that they are interested in obtaining user patterns of program execution. In contrast, our techniques are intended for use during the earlier stages of software development, to give developers immediate feedback on changes they make.

Law and Rothermel present PathImpact, a dynamic impact analysis that is based on whole-path profiling. See Larus, J., Whole program paths. In Proc. of the ACM SIGPLAN Conf. on Programming Language Design and Implementation (May 1999), pp. 1-11. In this approach, if a procedure p is changed, any procedure that is called after p, as well as any procedure that is on the call stack after $p$ returns, is included in the set of potentially impacted procedures. Although our analysis differs from that of Law and Rothermel in its goals (i.e., finding affected program entities versus finding changes affecting tests), both analyses use the same method-level granularity to describe change impact.

A recent empirical comparison of the dynamic impact analyses CoverageImpact by Orso et al. and PathImpact by Law and Rothermel revealed that the latter computes more precise impact sets than the former in many cases, but uses considerably (7 to 30 times) more space to store execution data. Based on the reported performance results, the practicality of PathImpact on programs that generate large execution traces seems doubtful, whereas CoverageImpact does appear to be practical, although it can be significantly less precise. See Orso, A., Apiwattanapong, T., Law, J., Rothermel, G., and Harrold, M. J., An empirical comparison of dynamic impact analysis algorithms. Proc. of the International Conf. on Software Engineering (ICSE'04) (Edinburgh, Scotland, 2004), pp. 491-500. Another outcome of the study is that the relative difference in precision between the two techniques varies considerably across (versions of) programs, and also depends strongly on the locations of the changes.

Zeller introduced the delta debugging approach for localizing failure-inducing changes among large sets of textual changes. Efficient binary-search-like techniques are used to partition changes into subsets, executing the programs resulting from applying these subsets, and determining whether the result is correct, incorrect, or inconclusive. An important difference with our work is that our atomic changes and interdependences take into account program structure and dependences between changes, whereas Zeller assumes all changes to be completely independent. Furthermore, the present invention does not require repeated execution of a program to identify failure-inducing changes, as is the case in Zeller's work. See Zeller, A., Yesterday my program worked. Today, it does not. Why? In Proc. of the 7th European Software Engineering Conf./7th ACM SIGSOFT Symp. on the Foundations of Software Engineering (ESEC/FSE'99) (Toulouse, France, 1999), pp. 253-267.

### 4.2 Regression Test Selection

Selective regression testing aims at reducing the number of regression tests that must be executed after a software change. We use the term selective regression testing broadly here to indicate any methodology that tries to reduce the time needed for regression testing after a program change, without missing any test that may be affected by that change. See Rothermel, G., and Harrold, M. J., A safe, efficient regression test selection technique. ACM Trans. on Software Engineering and Methodology 6, 2 (April 1997), 173-210 and Orso, A., Shi, N., and Harrold, M. J., Scaling regression testing to large software systems. Proceedings of the 12th ACM SIGSOFT Symposium on the Foundations of Software Engineering (FSE 2004) (Newport Beach, Calif., 2004). These techniques typically determine the entities in user code that are covered by a given test, and correlate these against those that have undergone modification, to determine a minimal set of tests that are affected.

Several notions of coverage have been used. For example, TestTube uses a notion of module-level coverage, and DejaVu uses a notion of statement-level coverage. See Chen, Y., Rosenblum, D., and Vo, K., Testtube: A system for selective regression testing. In Proc. of the 16th Int. Conf. on Software Engineering (1994), pp. 211-220; and Rothermel, G., and Harrold, M. J., A safe, efficient regression test selection technique. ACM Trans. on Software Engineering and Methodology 6, 2 (April 1997), 173-210 (DejaVu).

The emphasis in this work is mostly on reducing the cost of running regression tests, whereas our interest is primarily in assisting programmers with understanding the impact of program edits.

Bates and Horwitz and Binkley proposed fine-grained notions of program coverage based on program dependence graphs and program slices, with the goal of providing assistance with understanding the effects of program changes. In comparison to our work, this work uses more costly static analyses based on (interprocedural) program slicing and considers program changes at a lower-level of granularity, (e.g., changes in individual program statements). See Bates, S., and Horwitz, S., Incremental program testing using program dependence graphs. In Proc. of the ACM SIGPLAN-SIGACT Conf. on Principles of Programming Languages (POPL'93) (Charleston, S.C., 1993), pp.˜384-396; and Binkley, D., Semantics guided regression test cost reduction, IEEE Trans. on Software Engineering 23, 8 (August 1997).

The technique for change impact analysis of this embodiment uses affected tests to indicate to the user the functionality that has been affected by a program edit. Our analysis determines a subset of those tests associated with a program which need to be rerun, but it does so in a very different manner than previous selective regression testing approaches, because the set of affected tests is determined without needing information about test execution on both versions of the program.

Rothermel and Harrold present a regression test selection technique that relies on a simultaneous traversal of two program representations (control flow graphs (CFGs) in Rothermel and Harrold (1997) to identify those program entities (edges in Rothermel and Harrold (1997)) that represent differences in program behavior. See Rothermel, G., and Harrold, M. J., A safe, efficient regression test selection technique. ACM Trans. on Software Engineering and Methodology 6, 2 (April 1997), 173-210.

The technique then selects any modification-traversing test that is traversing at least one such “dangerous” entity. This regression test selection technique is safe in the sense that any test that may expose faults is guaranteed to be selected. Harrold, M. J., Jones, J. A., Li, T., Liang, D., Orso, A., Pennings, M., Sinha, S., Spoon, S. A., and Gujarathi, A., Regression test selection for Java software. In Proc. of the ACM SIGPLAN Conf. on Object Oriented Programming Languages and Systems (OOPSLA'01) (October 2001), pp. 312-326 present a safe regression test selection technique for Java that is an adaptation of the technique of Rothermel and Harrold. In this work, Java Interclass Graphs (JIGs) are used instead of control-flow graphs. JIGs extend CFGs in several respects: Type and class hierarchy information is encoded in the names of declaration nodes, a model of external (unanalyzed) code is used for incomplete applications, calling relationships between methods are modeled using Class Hierarchy Analysis, and additional nodes and edges are used for the modeling of exception handling constructs.

The method for finding affected tests presented in this embodiment is also safe in the sense that it is guaranteed to identify any test that reveals a fault. However, unlike the regression test selection techniques such as Rothermel and Harrold (April 1997), and Harrold et al (2001) our method does not rely on a simultaneous traversal of two representations of the program to find semantic differences. Instead, we determine affected tests by first deriving from a source code edit a set of atomic changes, and then correlating those changes with the nodes and edges in the call graphs for the tests in the original version of the program. Investigating the cost/precision tradeoffs between these two approaches for finding tests that are affected by a set of changes is a topic for further research. See Harrold, M. J., Jones, J. A., Li, T., Liang, D., Orso, A., Pennings, M., Sinha, S., Spoon, S. A., and Gujarathi, A., Regression test selection for Java software. In Proc. of the ACM SIGPLAN Conf on Object Oriented Programming Languages and Systems (OOPSLA'01) (October 2001), pp. 312-326

In the work by Elbaum et al., a large suite of regression tests is assumed to be available, and the objective is to select a subset of tests that meets certain (e.g., coverage) criteria, as well as an order in which to run these tests that maximizes the rate of fault detection. The difference between two versions is used to determine the selection of tests, but unlike our work, the techniques are to a large extent heuristics-based, and may result in missing tests that expose faults. See Elbaum, S., Kallakuri, P., Malishevsky, A. G., Rothermel, G., and Kanduri, S. Understanding the effects of changes on the cost-effectiveness of regression testing techniques. Journal of Software Testing, Verification, and Reliability (2003).

The change impact analysis of Orso can be used to provide a method for selecting a subset of regression tests to be rerun. First, all the tests that execute the changed program entities are selected. See Orso, A., Apiwattanapong, T., and Harrold, M.J., Leveraging field data for impact analysis and regression testing. In Proc. of European Software Engineering Conf. and ACM SIGSOFT Symp. on the Foundations of Software Engineering (ESEC/FSE'03) (Helsinki, Finland, September 2003). Then, there is a check if the selected tests are adequate for those program changes. Intuitively, an adequate test set T implies that every relationship between a program entity change and a corresponding affected entity is tested by a test in T. In their approach, they can determine which affected entities are not tested (if any). According to the authors, this is not a safe selective regression testing technique, but it can be used by developers, for example, to prioritize test cases and for test suite augmentation.

### 4.3. Controlling the Change Process

Palantir is a tool that informs users of a configuration management system when other users access the same modules and potentially create direct conflicts. See Sarma, A., Noroozi, Z., and van der Hoek, A., Palantir: Raising awareness among configuration management workspaces, Proc. of the International Conf. on Software Engineering (2003), pp. 444-454. Steyaert et al. describe reuse contracts, a formalism to encapsulate design decisions made when constructing an extensible class hierarchy. See Steyaert, P., Lucas, C., Mens, K., and D′Hondt, T., Reuse contracts: Managing the evolution of reusable assets. In Proc. of the Conf. on Object-Oriented Programming, Systems, Languages and Applications (1996), pp. 268-285. Problems in reuse are avoided by checking proposed changes for consistency with a specified set of possible operations on reuse contracts.

Therefore, while there has been described what is presently considered to be preferred embodiments, it will be understood by those skilled in the art that other modifications can be made within the spirit of the invention.

We claim:

1. A method comprising steps of:
obtaining an original version and a modified version of a program wherein each version has a set of associated tests;
determining a set of affected tests whose behavior may have changed as a result of one or more changes made to the original version to produce the modified version;
determining a set of changes responsible for changing the behavior of at least one affected test; and
classifying at least one member of the set of changes according to the way the member impacts at least one of the tests.

2. The method of claim 1, wherein the step of determining a set of affected tests comprises creating a structured representation of the changes.

3. The method of claim 1, wherein the set of associated tests comprises associated unit/regression tests.

4. The method of claim 1, wherein the step of obtaining an original version and a modified version of a program comprises the construction of an abstract syntax tree for each version and deriving a set of atomic changes with interdependencies, from the abstract syntax trees.

5. The method of claim 1 wherein the step of determining set of affected tests comprises constructing a call graph for each test.

6. The method of claim 1 further comprising a step of determining a set of changes that, when applied to the original version of the program, result in a version of the program for which all tests result in a version of the program for which all tests have the same outcome as in the original program.

7. The method of claim 1 further comprising a step of determining a set of changes that, when undone, result in a version of the program for which all tests result in a version of the program for which all tests have the same outcome as in the original program.

8. The method of claim 1 wherein the step of determining a set of affected tests comprises constructing a call graph for each test.

9. The system of claim 5 wherein the step of determining a set of affected tests comprises creating a structured representation of changes made to the original version to produce the modified version.

10. The method of claim 1 wherein the step of providing a classification comprises classifying changes into at least one of the following categories: untested changes; and
changes successfully tested.

11. The method of claim 1 wherein the step of providing a classification comprises classifying changes into at least one of the following categories:
changes only affecting failing tests;
changes affecting both successful and failing tests;
changes only affecting successful tests; and
changes not covered by any tests.

12. The method of claim 1 further comprising a step of visualizing the classified changes in a programming environment.

13. The method of claim 11 wherein the step of providing a classification comprises associating a color or image with each category of change.

14. The method of claim 1 wherein for each version of the program, each test has a status.

15. The method of claim 14 where the status comprises at least one of success and failure.

16. The method of claim 15 where wherein the failure status comprises one of assertion failure, exception and non-determination.

17. The method of claim 14 further comprising a step of visualizing the classified changes in a programming environment or testing tool.

18. A method comprising steps of:
receiving an original version of a program; and
receiving a modified version of the program, obtained by applying a set of changes to the original version of the program;
determining at least one affected test whose behavior may have changed;
for each affected test, determining a subset of changes that may have affected the behavior of that test;
determining a subset of the changes that can be committed to a repository;
wherein the program is covered by a set of regression tests; and for each version of the program, each test has a status comprising at least one of success, assertion failure, and exception.

19. A machine readable medium comprising instructions for:
obtaining an original version and a modified version of a program, wherein each version has a set of associated tests;
determining at least one affected test whose behavior may have changed as a result of one or more changes made to the original version to produce the modified version;
determining a set of changes that may have affected the behavior at least one affected test; and
classifying at least one member of the set of changes according to the way the member impacts at least one test.

20. An information processing system comprising:
an input for obtaining an original version and a modified version of a program, wherein each version has a set of associated tests;
a processor configured to determine a set of affected tests whose behavior may have changed as a result of one or more changes made to the original version to produce the modified version and to determine a set of changes that may have affected the behavior of at least one affected test; and
an output for providing a classification for at least one member of the set of changes that affected each affected test, wherein the classification is based on the way in which the changes impact at least one of the tests.
